(19) United States
(12) Patent Application Publication
(10) Pub. No.: US 2023/0047608 A1
(43) Pub. Date: Feb. 16, 2023

(54) METHOD FOR CONVEYING PERSONALISED INFORMATION TO A USER OF A BUILDING

(71) Applicant: INVENTIO AG, Hergiswil (CH)

(72) Inventor: Florian Trösch, Erlenbach ZH (CH)

(21) Appl. No.: 17/786,743

(22) PCT Filed: Dec. 1, 2020
(86) PCT No.: PCT/EP2020/084079

§ 371 Date: Jun. 17, 2022

(30) Foreign Application Priority Data
Dec. 20, 2019 (EP) 19218505.6

(51) Int. Cl. G07C 9/22; G07C 9/27; G07C 9/28; G07C 9/00

(52) U.S. Cl. CPC G07C 9/22; G07C 9/27; G07C 9/28; G07C 9/00309; G07C 9/00896; G07C 2009/00769

(57) ABSTRACT

In a building communication system for a building, a server device is provided which has a processor device and a storage device connected thereto, the storage device storing data sets in which display information that is predetermined for visitors is provided. An optical code is provided on the building, which optical code can be read by a mobile device of a visitor. In order to contact a resident of the building, the visitor scans the optical code with a mobile device. If the visitor is known in the system, the server device sends the display information predetermined for the visitor to their mobile device, which displays the personalized display information on a display of the mobile device.

### TECHNICAL FIELD

The technology described herein relates generally to a building system that performs one or more services in or for a building. Embodiments of the technology relate in particular to a building system that performs a communication service between a resident of the building and a visitor to the building, and to a method for operating such a building system.

### SUMMARY

Access to buildings such as office buildings and residential buildings is often restricted and front doors are locked so that visitors cannot enter the building without obtaining permission or authorization from a resident of the building. The visitor usually rings the doorbell of the resident they wish to visit in order to request access. For this purpose, equipment such as nameplates, along with associated doorbell buttons, are located next to an entrance to the building in order to allow the visitor to determine who is a resident of the building and to alert the resident that a visitor is waiting at the entrance. The alerted resident will then typically make contact with the visitor via an intercom system installed within the building. Once the resident has verified the visitor's identity, they can provide access into the building by unlocking the front door. Normally, the resident can unlock the front door remotely through the intercom system. A disadvantage of the currently required equipment (e.g. nameplates, doorbell buttons and intercom system) is the cost involved in installing and maintaining it. In addition, it usually requires special wiring within the building and imposes certain restrictions on the design of the building (since significant space is required at the entrance, in particular in large buildings with many residents). In addition, nameplates must be kept up to date as residents change.

WO 2016/087478 A1 discloses a system in which a mobile device of a visitor receives entrance identification information from a radio device by radio when said visitor is in the immediate vicinity of a building entrance. The mobile device sends the entrance identification information to a remote server which, based on the entrance identification information, determines a list of the residents of the building and sends this to the mobile device. The visitor can select and contact the desired residents from the list.

The system known from WO 2016/087478 A1 avoids the disadvantages mentioned above. Depending on the building and application, the required radio equipment can result in relatively high costs. There is therefore a need for a building system that is less expensive to produce and operate.

One aspect of such technology relates to a method for operating a building system for conveying personalized information to a visitor of a building. A server device is provided for the building, which server device has a processor device and a storage device communicatively connected to the processor device, and stores data which are provided for determining display information that is predetermined for visitors. An optical code associated with the building can be read by a mobile device of a visitor while the visitor is outside the building or in a public zone within the building. According to the method, a first data signal is received by means of the processor device, the first data signal comprising a building identifier which results from the optical code when it is read by the mobile device of the visitor and conveyed to the processor device. The building identifier indicates the building where the visitor is located in order to contact a resident. The processor device determines whether a first identifier associated with the visitor is received with or in connection with the first data signal, wherein if the first identifier is received, the visitor is a known visitor, and otherwise the visitor is an unknown visitor. If the first identifier is received, the storage device is searched by the processor device for an identifier stored for the building identified by the building identifier that is identical to the first identifier. If the search is successful, the processor device is used to determine the display information predetermined for the visitor from the data and by means of the first identifier. A second data signal is sent from the server device to the mobile device of the visitor, the second data signal comprising the display information predetermined for the visitor and causing the mobile device to display the display information on a screen of the mobile device.

Another aspect of the technology relates to a building communication system for a building on which an optical code is arranged in such a way that it can be read by a mobile device of a visitor while the visitor is outside the building or in a public zone within the building. The building communication system comprises a server device which has a processor device and a storage device communicatively connected to the processor device. The storage device stores data that are provided for determining display information predetermined for visitors. The processor device is configured to receive a first data signal, the first data signal comprising a building identifier which results from the optical code when it is read by the mobile device of the visitor and conveyed to the processor device. The building identifier indicates the building where the visitor is located in order to contact a resident. The processor device is configured to determine whether a first identifier associated with the visitor is received with or in connection with the first data signal, wherein if the first identifier is received, the visitor is a known visitor, and otherwise the visitor is an unknown visitor. The processor device is also configured, if the first identifier is received, to search the storage device for an identifier stored for the building identified by the building identifier that is identical to the first identifier. If the search is successful, the processor device determines the display information predetermined for the visitor from the data and by means of the first identifier. The processor device is also configured to send a second data signal from the server device to the mobile device of the visitor, the second data signal comprising the display information predetermined for the visitor and causing the mobile device to display the display information on a screen of the mobile device.

The technology described herein provides a building communication system in which there is neither a need for nameplates and doorbell buttons at the building entrance of the building, nor a need for installing an intercom system in the building. The visitor uses their own mobile device to contact a resident in the building; for this purpose, the visitor is initially required to scan an optical code with the mobile device. However, an electronic locking device can be provided at the building entrance in connection with an access control system in order to grant the visitor access after authorization by a resident, for example by automatically unlocking or releasing a door, a gate, or a mechanical or optical turnstile.

The technology described also provides a building communication system in which the information displayed to the visitor on their mobile device screen in response to the scanned optical code depends on who the visitor is or in what capacity they wish to contact the resident. A visitor who is known in the system because they are e.g. registered, logged in or regularly in the building has different display information displayed on the screen of their mobile device than an unknown visitor. For example, an unknown visitor only sees a public message, e.g. that the displayed building function “Reception” is to be selected for further information. A known visitor, on the other hand, can be shown more detailed information which may not be public, such as names and addresses (e.g. floor and/or apartment number in the building), a welcome note (e.g. “Welcome to ABC” or “Welcome ‘Visitor's name’”), an availability or absence notice (e.g. a message “Be right back,” “Back from 6:00 p.m.” or “Do not disturb”), or moving information with details of the new address. The better known or more familiar the visitor is, the more non-public information can be conveyed to them. This type of information is provided by a server, i.e. from a central source; it can be defined centrally by the resident and changed if necessary.

In one embodiment, an unknown visitor is identified in that the processor device, when searching the storage device, does not determine any stored identifier that is equal to the first identifier. The processor device then generates a third data signal, which is sent to the mobile device. The third data signal comprises display information which is independent of the visitor and causes the mobile device to display the display information which is independent of the visitor on the screen of the mobile device. The above-mentioned public message is displayed in this case.

In one embodiment, the optical code comprises a QR code (Quick Response code). For example, the QR code encodes a web address. In one embodiment, the QR code is printed on a carrier material that is attached to the building at a point accessible to visitors (e.g. by means of adhesive bonding). Carrier materials that can be attached in this way are inexpensive and can be arranged quickly and relatively flexibly with regard to location. A person skilled in the art recognizes that, as an alternative to a printed QR code, an electronic display unit can be used that displays a static or dynamic QR code on its screen (e.g. an LCD display); the displayed optical code can also be a color code. Additionally, a person skilled in the art will recognize that the optical code may include a printed or electronically displayed bar code. The bar code encodes e.g. a numeric code that is assigned to a specific building in a database. The optical code, with a QR code, a bar code or another optical code, can also be attached in a space-saving manner.

In one embodiment, the optical code can be configured to be suitable for the disabled. Said carrier material can, for example, be provided with a marking that can be perceived by touch. A visitor with impaired vision can therefore feel the location of the optical code and then scan it with the mobile device they are typically familiar with. The marking can, for example, include information in Braille. Additionally or alternatively, the location of the optical code may be acoustically indicated to such a user, e.g. by a buzzer or other selective acoustic signal source. The buzzer or the acoustic signal source can be arranged at the location of the carrier material or in its immediate vicinity. In an electronic display unit, the buzzer or the acoustic signal source can be arranged in the display unit. The acoustic signal source can, for example, generate a voice message for using the optical code when the visitor approaches.

According to the technology described herein, the processor device can establish a communication connection between the mobile device of the visitor and a communication device of the resident to be contacted. Information about the resident to be contacted is included in the display information predetermined for the visitor; it may include a resident's name and/or their function.

A resident (or owner) is a person who works or lives in the building and can respond to a contact request (e.g. a phone call) from a visitor when the visitor is at the building. The response may be that the resident accepts the contact request and talks to the visitor via telecom and/or grants them access to the building. On the other hand, a visitor is a person who wants to contact a resident, e.g. to gain access to the building.

In one embodiment, the establishment of the connection between the mobile device and the communication device is thus controlled by the web server and in particular the provision of contact information of the visitor and/or the resident, such as a telephone number or a user name, to the visitor and/or the resident is explicitly excluded. In this way, the exchange of personal information can be prevented, which would not be the case, for example, when using a standard voice call, where the initiator of the call requires, for example, the mobile phone number of the recipient.

In one embodiment, the building communication system can be configured in such a way that the visitor must actually be present at the building if contact with a resident 6 is desired. For this purpose, in one embodiment, a device used for location verification must be arranged on or near the building. This device can comprise, for example, a beacon transmitter (also referred to as a beacon) with a fixed range (in particular a relatively short range of less than approximately 5 m), e.g. a Bluetooth Low Energy (BLE) device. Alternatively, the device may comprise a near-field communication (NFC) radio device. In addition, the device can also be part of a wireless local area network (WLAN). If no such device is provided on the building, position or location information derived from the mobile device (e.g. using GPS) can be used. A mobile device that can determine its location can be set to always use the determined location or to ask the user each time whether the location can be used. These examples make it clear that there are several options for location verification that can be flexibly selected depending on the building and the local conditions.

The location data determined in this way indicate a location at which the mobile device is located, in particular substantially at the time the first data signal was received. The processor device can use the received location data to determine whether the location indicated by the location data is at the building. If this is the case, the visitor is also at the building. If, on the other hand, this is not the case, the processor device can prevent the establishment of the communication connection. Depending on the configuration of the building communication system, the processor device can, in one embodiment, send a message to the mobile device in order to inform the visitor of the reason for the failure of the communication connection.

In one embodiment, the method further comprises sending information related to the visitor to the web server. Such information may include a personal user profile of the visitor. This information can be used, for example, to (validly) identify the visitor and then provide customized or personalized information to the visitor, e.g. a welcome message or possibly an access code.

In a further embodiment, establishing the connection between the mobile device of the visitor and the communication device of the resident comprises establishing a voice over IP (VOIP) connection between these devices, in particular an audio connection or a video connection. This allows the resident to communicate with the visitor in at least the same way as using a standard integrated intercom system without the need to install such an expensive system.

In one embodiment, establishing the connection between these devices may comprise sending a message from the mobile device to the communication device of the resident via the web server. The message received by the web server from the mobile device is thereby sent to the communication device. Accordingly, a response message can be sent from the communication device to the web server, which then sends the response message to the mobile device. In this way, an instant messaging or chat function is provided, allowing the visitor and resident to exchange text messages. The advantage of using such a push mechanism is that it is not required for either the initiator or the receiver to know, for example, a username or other credentials of the other party.

In a further embodiment of the method, the establishment of the connection between the mobile device and the communication device is achieved at least in part via a mobile/cellular network, such as a Universal Mobile Telecommunications System (UMTS, 3G standard) or a Long-Term Evolution (LTE, 4G standard) network.

With the technology described herein, it is also an advantage that the privacy of a resident is better protected. Rather than having their name affixed to a nameplate on the building or having their name included in an electronic list sent to each visitor who reports to the building entrance, the technology described herein avoids this. For example, the names of the residents are not disclosed arbitrarily, but are personalized in relation to the visitor.

In another embodiment, the communication device is a device belonging to a third party other than the resident, e.g. a proxy, such as an officer, receptionist, caretaker, call center, or security or emergency service, in particular located at a location other than an office or home of the resident. In this way, it is possible for the resident to delegate the provision of information to the visitor to a proxy in the event that the resident is not present in the building or is busy and cannot immediately deal with a visitor's query.

In one embodiment, the second data signal is sent by the web server to the mobile device of the visitor by sending data and/or a script such as HTML, JavaScript, CSS or Adobe Flash to a client, in particular a thin client such as a web browser, which is executed by the mobile device as a web application.

### BRIEF DESCRIPTION OF THE DRAWINGS

Various aspects of the improved technology are described in greater detail below with reference to embodiments in conjunction with the drawings. In the drawings, like elements have like reference signs. In the drawings:

FIG. 1 is a schematic representation of an application example of a building communication system in connection with an example of a situation in a building; and

FIG. 2 is a flowchart of an embodiment of a method for operating the building communication system.

### DETAILED DESCRIPTION

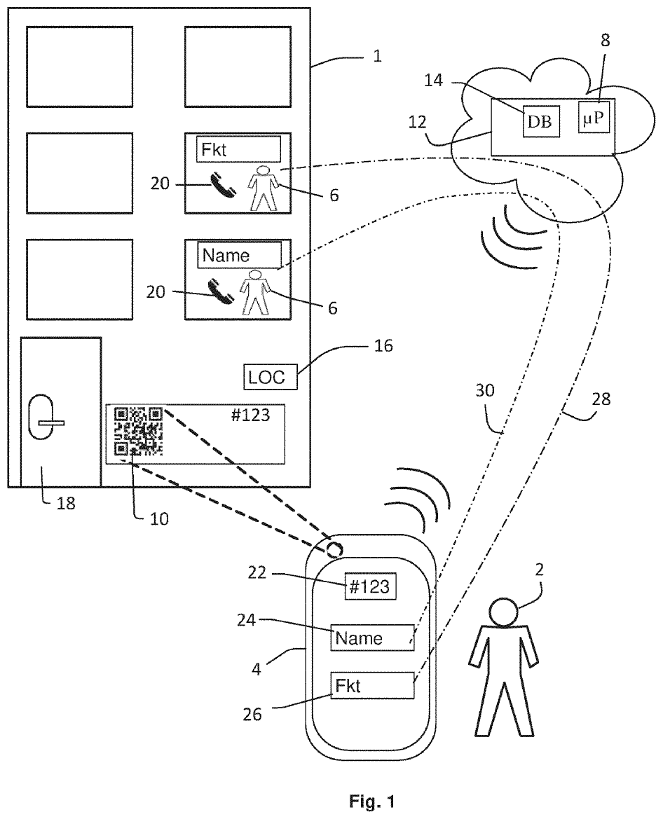

FIG. 1 is a schematic representation of an application example of a building communication system in connection with an example of a situation in a building 1. The building 1 may be a commercial building with offices and/or other commercial premises or a residential building with several flats/apartments. A person skilled in the art recognizes that the technology described herein is not limited to a single building 1. People who are in the building 1 because they work or live there are referred to as residents 6 in this description. The residents 6 can be identified by their names (Name(s)) and/or their functions (Fkt(s)) (e.g. building management, building cleaning, etc.). In FIG. 1, a person 2 who wants to contact a resident 6 and/or gain access to the building 1 is located in front of the building 1. The person 2 who is in front of the building 1 is referred to in this description as a visitor 2; this can be a first-time or regular visitor 2 or a visitor 2 who visits the building 1 for a repeated time. The visitor 2 can also work or live in the building 1 and still wish to contact a resident 6, e.g. a work colleague or a family member.

As indicated in FIG. 1, the visitor 2 and the residents 6 have communication devices (4, 20) at their disposal. The visitor 2 carries a mobile device 4 which can be, for example, a mobile telephone, a smartphone, or a tablet PC. These devices are typically equipped with hardware, software, and firmware to provide, for example, a communication function, digital image and video function, and a graphical user interface (GUI). The communication function allows communication via a local radio network (WLAN/WiFi) and/or a global mobile radio network according to a mobile radio standard (e.g. GSM, LTE, G4, G5). The digital image and video function can also be used to scan an optical/visual code 10. Depending on the configuration of the mobile device 4, it can comprise application-specific software (so-called apps), for example.

FIG. 1 shows an example of an optical code 10 in the form of a QR code. Further examples of an optical code 10 and details on QR codes are given elsewhere in this description. In the embodiment shown, the optical code 10 is arranged on the building 1 so that it can be seen by the visitor 2 who is outside the building 1 in the situation shown. The optical code 10 can be arranged, for example, on the outside of the building 1, for example on an outer wall of the building in connection with a house number (#123) near a building entrance 18 or on a building door. A sign can also be arranged there, which informs the visitor 2 that the optical code 10 has to be scanned in order to contact a resident 6. FIG. 1 indicates that the visitor 2 holds the mobile device 4 to the optical code 10 in such a way that the optical code 10 can be scanned and read, i.e. the mobile device 4 runs a software application which determines the information encoded in the optical code 10. With a QR code, the encoded information typically includes a web address (URL).

FIG. 1 also shows a storage device 14, in which a database system (DB) is implemented, and a processor 8 (μP) communicatively connected thereto, which is provided for control and processing functions. In one embodiment, the storage device 14 and the processor 8 are arranged remotely from the building 1 and combined to form a web server 12. The web server 12 provides an IT infrastructure made available via the Internet (also referred to as “cloud computing”). The communicative connection between the web server 12, the mobile device 4 and the communication devices 20 of the residents 6 takes place via a communication network, for example a mobile network.

Depending on the storage requirement, the storage device 14 comprises, for example, a hard disk drive (HDD), a CD/DVD drive, a semiconductor drive/solid state disk (SSD) or combinations thereof, or other storage devices for digital data. The database system consists of two parts: management software, referred to as a database management system, and a set of data to be managed. The management software organizes the structured storage of the data internally, and controls all reading and writing access to the database. In one embodiment, the database system is a relational database system. A database system offers a database language for querying and managing the data, e.g. the language SQL in a relational database system.

The database system saves one or more data sets for the building 1 and for any other building that may be present. The stored data can, for example, be organized according to information about the residents 6 of the building 1, e.g. stored in a data set. This information may include: personal data of the residents 2, e.g. name, function (resident, employee of a company), telephone number(s), e-mail address(es), social media information, access authorizations (e.g. no restrictions or certain rooms and floors) and possible time access restrictions (e.g. no restrictions or access from Monday to Friday, from 7:00 a.m. to 8:00 p.m.). The stored data can also be organized according to functions present in the building 1, e.g. in another data set. For example, the functions present in the building 1 may include: caretaker, building cleaning service, post office, reception, building administration/building management.

The organization and management of the data can be carried out by the building management, for example. However, the residents 6 can determine which data are stored in a resident profile created for them. The resident 6 can, for example, set one or more rules about how they want to be contacted (e.g. by phone or text message), when (e.g. only during the day or during business hours, not after 8:00 p.m.), by whom (e.g. only from known people and parcel delivery services) and by whom not (e.g. unknown people; these can be referred to a caretaker) and/or when absent (e.g. with or without a message or forwarding). As a result, the resident can specify, among other things, which visitors 2 can contact them, when and how.

Depending on the design of the system, an optional device 16 (LOC) can be arranged on or near the building 1, which is used for location verification. Such a device 16 can, for example, be a beacon transmitter (also referred to as a beacon) with a short range, e.g. a Bluetooth Low Energy (BLE) device with a limited transmission range of e.g. 10 to 30 meters. Alternatively, the device 16 may comprise a near-field communication (NFC) radio device. In addition, the device 16 may also be part of a wireless local area network (WLAN). The device 16 transmits, for example, an identifier for the device 16 that is assigned to the building 1 in the web server 12, or an identifier for the building 1. The mobile device 4 is configured to send the identifier read by the device 16 to the web server 12.

If no device 16 is provided on the building 1, position or location information derived from the mobile device 4 can be used. A mobile device that can determine its location can be set to always use the determined location or to ask the user each time whether the location can be used.

When location verification is implemented, it occurs substantially at the same time as the optical code 10 is scanned, i.e. according to one embodiment the processor device 8 checks whether location information of the mobile device 4 is present in connection with a received data signal which emerges from the read optical code 10. If the location of the mobile device 4 matches the location of the building 1, the processor device 8 recognizes that the visitor 2 is at the building 1.

By means of the device 16 it can be ensured, if required, that the visitor 2 actually has to be present at the building 1 if contact with a resident 6 is desired. Alternatively, the visitor 2 could, for example, take a photo of the optical code 10, move away from the building 1 and at a later time away from the building 1 scan the optical code from the photo to contact a resident 6.

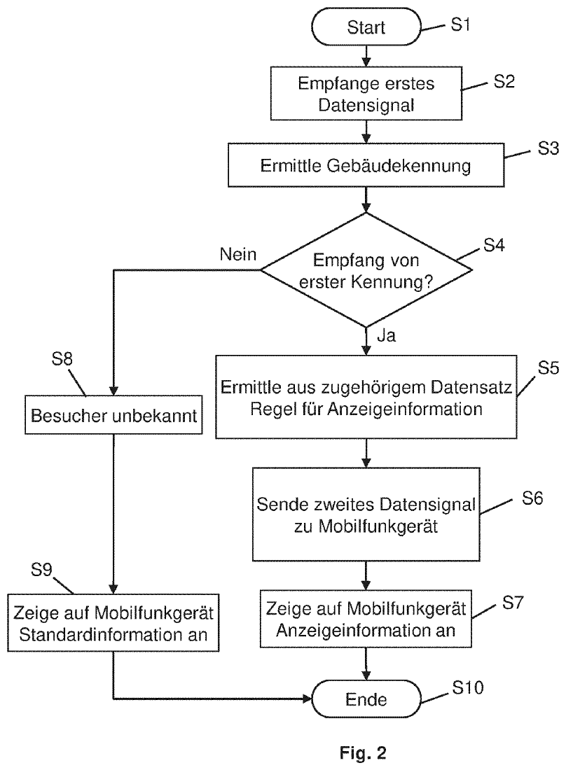

Based on the example of a situation shown in FIG. 1, a description of further details regarding the system structure and for carrying out various embodiments of the method based on the technology described herein is given below. In this context, reference is made to the flowchart of an embodiment of the method shown by way of example in FIG. 2; the method starts in a step S1 and ends in a step S10. The visitor 2 who wants access to a building 1 will first look for an entrance 18 in order to enter the building 1. Typically, the visitor 2 will not be able to enter the building 1 because, for example, a physical barrier (e.g. a door) prevents unauthorized entry into the building 1.

For example, in order to register and request permission to enter the building 1, the visitor 2 must contact the resident 6 they wish to visit or someone else (e.g. a third party), such as a receptionist, caretaker or a reception who/which is authorized to give the visitor 2 information and possibly access to the building 1. When the visitor 2 is at or in close proximity to the entrance 18, the visitor 2 perceives the optical code 10 with an instruction that it is to be scanned. Following the instruction, the visitor 2 scans the optical code 10 with their mobile device 4 in order to contact the desired resident 6 (or a third party).

The information that the scanner software application determines from the optical code 10 is then transmitted by the mobile device 4 to the web server 12, e.g. via a mobile network (3G/4G, UMTS/LTE) to which the mobile device 4 is connected. In a step S2 of the method, the processor device 8 receives a first data signal comprising a building identifier which results from the optical code 10 when it is read by the mobile device 4 of the visitor 2 and conveyed to the processor device 8.

In a step S3 of the method, the processor device 8 determines the building identifier; it indicates the building 1 on which the optical code 10 is arranged and in which the visitor 2 would like to contact a resident 6. This building-related information includes information that specifies the building 1. In one embodiment, the information includes a (Internet) web address (also referred to as a web link or URL (Uniform Resource Locator)), the web address allowing access to a software application that the web server 12 executes.

In addition to the building-related information, the mobile device 4 can also transmit information relating to the visitor 2, e.g. the identifier of the mobile device 4 (phone number, MAC address) or a (user) name, to the web server 12. In a step S4 of the method, the processor device 8 determines whether a first identifier associated with the visitor 2 is received with or in connection with the first data signal; if the first identifier is received, the visitor is a known visitor 2 and the method proceeds along the yes branch to a step S5; otherwise the visitor is an unknown visitor 2 and the method proceeds along the no branch to a step S8.

If the visitor 2 is a returning or regular visitor 2 or a resident 2, i.e. a known visitor 2, a software application can be installed on their mobile device 4, which generates an identification number permanently assigned to the mobile device 4, i.e. each time the software application is run, it generates the same identification number. If the visitor 2 is known in the system, the identifier of the mobile device 4 and/or the identification number can be stored in the storage device 14 of the web server 12, for example. This user-specific information can be stored in a visitor profile of visitor 2 or in a resident profile, i.e. a resident 6 can specify the user-specific information in their resident profile, e.g. the name and/or the function of the visitor 2, the identifier of the mobile device 4 and/or the identification number.

On the basis of the information received, the web server 12 can then determine at which building 1 the known or unknown visitor 2 is waiting. Depending on this, the web server 12 causes the storage device 14 or the database to be searched. The processor device 8 searches the storage device 14 for a mobile device identifier stored in the data sets for the building 1 specified by the building identifier that is identical to the first identifier. If this is the case, i.e. the search is successful, the processor device 8 uses the data set in which the first identifier is stored to determine a rule which defines the display information predetermined for the visitor 2 (step S5).

In a step S6 of the method, the web server 14 sends a second data signal to the mobile device 4 of the visitor 2. The second data signal comprises the display information predetermined for the visitor 2. In a step S7 of the method, the mobile device 4 then causes the display information to be displayed on a screen of the mobile device 4. The method ends in step S10.

If it is determined in step S4 that no first identifier is received, according to step S8, the visitor is an unknown visitor 2. In this case, the processor device 8 generates a third data signal and sends it to the mobile device 4. The third data signal comprises standard information, i.e. display information, which is independent of the visitor 2. In a step S9 of the method, caused by the third data signal, the standard information is displayed on a screen of the mobile device 4. The method ends in step S10.

The information displayed indicates which resident or residents 6 or which function or functions the visitor 2 can contact. The one or more contact options thus also depend on the visitor 2, e.g. whether they and/or their function are known or unknown in the system. The visitor 2 can then arrange for a resident 6 or a function to be contacted, e.g. by touching the name of the desired resident displayed on the screen 6.

The information regarding the desired resident 6 is then used to establish a communication connection between the visitor 2 and the desired resident 6. Exemplary communication connections are indicated in FIG. 1 by connecting lines 28, 30. In one embodiment, the web server 12 establishes the communication connection between the visitor 2 and the desired resident 6, e.g. a voice over IP (VOIP) connection that provides both audio and video transmission. This has the advantage that the contact information (e.g. mobile device numbers) of the two parties (i.e. the visitor 2 and the resident 6) do not have to be explicitly provided to either party. For example, the resident 6 may receive the visitor's call using their communication device 20. The communication device 20 can be, for example, a landline telephone, a mobile device, or a computer. The communication device 20 and the mobile device 4 can use the same app in order to communicate using this app. However, a corresponding app could also run on the resident's 6 computer or tablet.

The resident 6 can then talk to the visitor 2 via the established audio connection and possibly also see the visitor 2 via the optional video connection. Instead of using such an audio/video connection, the visitor can alternatively (or additionally) communicate with the resident 6 (and vice versa) by means of an instant message or chat function provided by the app or via a web browser running on the communication devices (4, 20).

In one embodiment, the resident 6 can only communicate with the visitor 2. In one embodiment, the resident 6 can also grant the visitor 2 access into the building 1 by sending access granting information to an access control system configured to e.g. lock or unlock the door or gate at the entrance 18 and allow visitor 2 to enter. The access granting information can be sent directly to the access control system or provided to the visitor 2 so that said visitor has to provide the access granting information to the access control system. The latter has the advantage that the visitor 2 must be physically present at the entrance 18 in order to provide the access granting information to the access control system.

There are several options to provide the visitor 2 with the access granting information from the resident 6, e.g. via the WLAN installed within the building 1 or via the mobile network and the web server 12. The visitor 2 can then provide the access granting information directly to the access control means, e.g. by sending a code via BLE or NFC or by entering a code manually. Alternatively, the access granting information could be received from the mobile device 4 via an intermediate device, e.g. a BLE device, which is wired to the access control means, for example.

In the event that the resident 6 cannot or does not want to be connected to the visitor 2, they can temporarily or permanently delegate receiving calls from visitors to a proxy, such as a receptionist. This may be the case, for example, in an office such as a law firm or a dentist's office, where a receptionist at the front desk will answer all calls from visitors and allow them access into building 1.

Information as to whether a proxy should be contacted when a visitor 2 wishing to see a specific resident 6 is present can be provided to the web server 12 which then establishes an appropriate connection. The access granting information is then provided directly to the access control means by the proxy, or e.g. the mobile device 4 via the web server 12, from which it is provided to the access control means either directly or alternatively via the intermediate device.

The technology described herein proposes replacing the conventional method of granting access to a building, which is based on using equipment in the form of nameplates and associated doorbell buttons at the entrance together with a hard-wired intercom system for communication with the residents, with the method described herein, which is based on the use of a mobile device 4 in conjunction with optical codes 10, which are familiar to visitors 2 and are available at all times. By conveying the display information personalized to a visitor 2, a configurable and in particular personalized building communication system can be provided in an efficient and economical manner. A high degree of flexibility and reduced costs are achieved through the use of wireless technologies instead of rigid wired connections. In addition, the proposed method is well adapted to the modern trend toward an increasingly mobile society, where office workers and apartment dwellers frequently change their place of work and residence and require a system that can be updated quickly to follow these changes with little effort and to stay current.

The technology described herein also uses known services, including the technical properties thereof, for example with regard to transmission medium (e.g. radio, cable, Internet), addressing (Uniform Resource Locator (URL)) and transmission protocol (e.g. Internet protocols such as Internet Protocol (IP), Transmission Control Protocol (TCP), User Datagram Protocol (UDP), Hypertext Transfer Protocol (HTTP), Simple Mail Transfer Protocol (SMTP), File Transfer Protocol (FTP)) which are known to a person skilled in the art. Well-known social media or social networks are known, for example, under the following names: Facebook, Instagram, WhatsApp and WeChat.

1-15. (canceled)

16. A method for operating a building communication system for conveying personalized information to a visitor of a building,
wherein a server device is provided for the building, which server device has a processor device and a storage device communicatively connected to the processor device, wherein the storage device stores data which are provided for determining display information that is predetermined for visitors,
wherein an optical code assigned to the building can be read by a mobile device of a visitor while the visitor is outside the building or in a public zone within the building, wherein the method comprises:
receiving a first data signal by the processor device, wherein the first data signal comprises a building identifier which results from the optical code when it is read by the mobile device of the visitor and conveyed to the processor device, wherein the building identifier indicates the building at which the visitor is located in order to contact a resident;
determining, by the processor device, whether a first identifier associated with the visitor is received with or in connection with the first data signal, wherein when the first identifier is received, the visitor is a known visitor, and otherwise the visitor is an unknown visitor;
when the first identifier is received, searching, by the processor device, the storage device for an identifier stored for the building identified by the building identifier that is identical to the first identifier;
based on the search being successful, determining, by the processor device, the display information predetermined for the visitor from the data and the first identifier; and
sending a second data signal from the server device to the mobile device, wherein the second data signal comprises the display information predetermined for the visitor and causes the mobile device to display the display information on a screen of the mobile device.

17. The method of claim 16, further comprising establishing, by the processor device, a communication connection between the mobile device of the visitor and a communication device of the resident to be contacted, wherein the display information predetermined for the visitor comprises a name of the resident and/or their function.

18. The method of claim 17, further comprising receiving location data by the processor device, wherein the location data indicates a location at which the mobile device is located.

19. The method of claim 18, wherein the location data are location data determined and conveyed by the mobile device.

20. The method of claim 18, wherein the location data are determined by a detection device arranged on the building and are conveyed to the processor device.

21. The method of claim 18, further comprising determining, by the processor device, whether the location indicated by the location data is at the building and, if this is not the case, preventing the establishment of the communication connection.

22. The method of claim 21, further comprising sending a message, by the processor device, to the mobile device, wherein the message indicates a reason for preventing the establishment of the communication connection.

23. The method of claim 16, wherein the optical code comprises a QR code or a bar code.

24. The method of claim 16, wherein the first identifier comprises a telephone number assigned to the mobile device, a MAC (media access control) address of the mobile device and/or an identification number generated by a software application (app) installed on the mobile device, wherein the identification number is used to identify the mobile device and/or the visitor.

25. The method of claim 16, wherein if the search is not successful, a third data signal is generated by the processor device and sent to the mobile device, wherein the third data signal comprises display information which is independent of the visitor and causes the mobile device to display the display information which is independent of the visitor on the screen of the mobile device.

26. A building communication system for a building, on which an optical code is arranged in such a way that it can be read by a mobile device of a visitor while the visitor is outside the building or in a public zone within the building, the system comprising:
a server device which has a processor device and a storage device communicatively connected to the processor device, wherein the storage device stores data which are provided for determining display information that is predetermined for visitors, wherein the processor device is configured to:
receive a first data signal, wherein the first data signal comprises a building identifier which results from the optical code when it is read by the mobile device of the visitor and conveyed to the processor device, and wherein the building identifier indicates the building at which the visitor is located in order to contact a resident;
determine whether a first identifier associated with the visitor is received with or in connection with the first data signal, wherein if the first identifier is received, the visitor is a known visitor, and otherwise the visitor is an unknown visitor;
if the first identifier is received, search the storage device for an identifier stored for the building identified by the building identifier that is identical to the first identifier;
if the search is successful, determine the display information predetermined for the visitor from the data and the first identifier; and
send a second data signal from the server device to the mobile device of the visitor, wherein the second data signal comprises the display information predetermined for the visitor and causes the mobile device to display the display information on a screen of the mobile device.

27. The system of claim 26, wherein the processor device is further configured to establish a communication connection between the mobile device of the visitor and a communication device of the resident to be contacted, wherein the display information predetermined for the visitor comprises a name of the resident and/or their function.

28. The system of claim 26, wherein the processor device is further configured to receive location data, wherein the location data indicate a location at which the mobile device is located.

29. The system of claim 28, in which the processor device is further configured to determine whether the location indicated by the location data is at the building and, if this is not the case, to prevent the establishment of the communication connection.

30. The system of claim 26, wherein the optical code is provided with a marking which can be perceived by touch.

31. The system of claim 30, wherein the marking comprises a Braille marking.

32. The system of claim 26, wherein the wherein the optical code comprises a QR code or a bar code.
